(19) United States
(12) Patent Application Publication
(10) Pub. No.: US 2009/0157756 A1
(43) Pub. Date: Jun. 18, 2009

(54) File System For Storing Files In Multiple Different Data Storage Media

(75) Inventor: Marco Sanvido, Belmont, CA (US)

Correspondence Address: STEVEN J. CAHILL/ HITACHI GST, P.O. Box 779, MENLO PARK, CA, 94026-0779, US

(73) Assignee: Hitachi Global Storage Technologies Netherlands, B.V., Amsterdam (NL)

(21) Appl. No.: 11/957,438

(22) Filed: Dec. 15, 2007

(51) Int. Cl. G06F 17/30

(52) U.S. Cl. 707/200; 707/E17.01

(57) ABSTRACT

A host system includes a file system and a processor for executing the file system. The file system stores a first portion of a file in a first data storage medium and a second portion of the file in a second data storage medium based on an intrinsic value of at least a part of the file. In other embodiments, the file system stores a first file in a first data storage medium based on an intrinsic value of the first file and a second file in a second data storage medium based on an intrinsic value of the second file. The file system dynamically moves the second file from the second data storage medium to the first data storage medium in response to a change in the intrinsic value of the second file. The first and the second data storage media are different types of data storage media.

### CROSS-REFERENCES TO RELATED APPLICATIONS

This application is related to commonly assigned U.S. Patent Application ______, (Attorney Docket Number HSJ9-2007-0208-US1), filed concurrently herewith, to Marco Sanvido, which is incorporated by reference herein.

### BACKGROUND OF THE INVENTION

The present invention relates to data storage systems, and more particularly, to a file system that stores files in multiple different data storage media.

A hard disk drive is a type of data storage device. A hard disk drive stores data onto the surface of one or more hard disk platters as a magnetic image. Other types of data storage devices include flash memory devices and optical disk drives, such as CD and DVD drives.

### BRIEF SUMMARY OF THE INVENTION

According to some embodiments of the present invention, a host system includes a file system and a processor for executing the file system. The file system stores a first portion of a file in a first data storage medium and a second portion of the file in a second data storage medium based on an intrinsic value of at least a part of the file. The first and the second data storage media are different types of data storage media.

According to other embodiments of the present invention, a file system stores a first file in a first data storage medium based on an intrinsic value of the first file. The file system stores a second file in a second data storage medium based on an intrinsic value of the second file. The file system dynamically moves the second file from the second data storage medium to the first data storage medium in response to a change in the intrinsic value of the second file. The first and the second data storage media are different types of data storage media.

Various objects, features, and advantages of the present invention will become apparent upon consideration of the following detailed description and the accompanying drawings.

### BRIEF DESCRIPTION OF THE DRAWINGS

FIG. 1A illustrates a diagram of a computer system having multiple types of data storage media, according to an embodiment of the present invention.

FIG. 1B illustrates a diagram of another computer system having multiple types of data storage media, according to an embodiment of the present invention.

FIG. 2 illustrates an example of how a file system stores different parts of a file in different types of data storage media, according to an embodiment of the present invention.

FIG. 3 illustrates an example of how a file system stores a portion of a file in two different types of data storage media, according to an embodiment of the present invention.

FIG. 4A is a flow chart that illustrates a process for a file system to dynamically move a file from one type of data storage medium to another type of data storage medium, according to an embodiment of the present invention.

FIG. 4B is a flow chart that illustrates a process for a file system to dynamically move a portion of a file from one type of data storage medium to another type of data storage medium, according to an embodiment of the present invention.

### DETAILED DESCRIPTION OF THE INVENTION

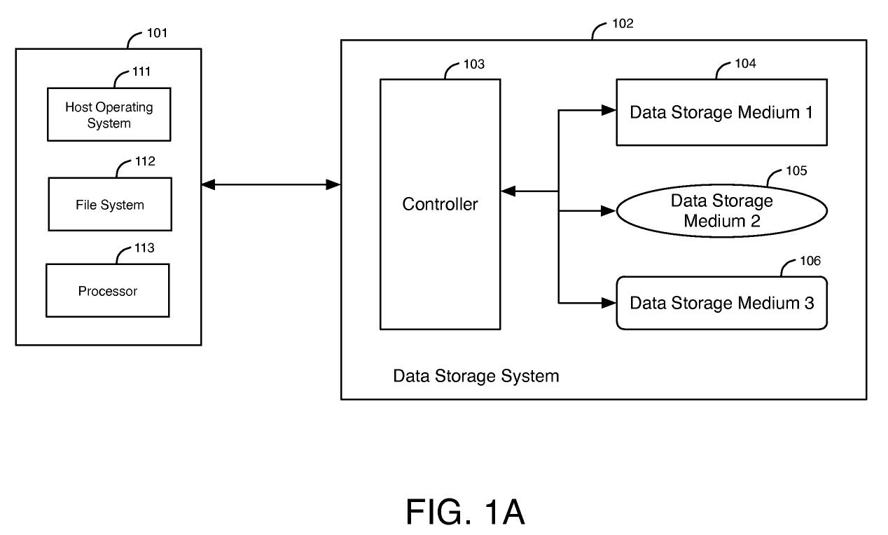

FIG. 1A illustrates a diagram of a computer system having multiple data storage media, according to an embodiment of the present invention. The computer system of FIG. 1A includes a host system 101 and a data storage system 102. Host system 101 includes a host operating system 111, file system software 112, and a processor 113. Operating system 111 and file system 112 are executed on processor 113. Host system 101 can be part of the same computer machine as data storage system 102 or part of a different computer machine. Host system 101 can be, for example, a personal computer, a network attached storage device having a network file system, a set-top box, a server computer, etc.

A file system is a technique for storing and organizing computer files to facilitate the process of locating the files. File system 112 can be used to manage data blocks that are stored on data storage system 102. The file system 112 organizes the data blocks into files and directories. The file system 112 also keeps track of which data blocks belong to which file and which data blocks are not being used.

Data storage system 102 includes a controller 103, a first data storage medium 104, a second data storage medium 105, and a third data storage medium 106. Controller 103 is typically fabricated on an integrated circuit. Controller 103 processes read and write commands from host system 101. Controller 103 also communicates with each of the data storage media 104-106 through one or more communications channels. Controller 103 causes data to be read from and written to data storage media 104-106 in response to read and write commands from host system 101.

Each of the data storage media 104-106 is a non-volatile data storage medium. In one embodiment, data storage system 102 is a single data storage device that has 3 different types of data storage media, such as, for example, an optical disk, a magnetic disk, magnetic tape, and non-volatile semiconductor memory.

FIG. 1B illustrates a diagram of another computer system having multiple types of data storage media, according to an embodiment of the present invention. Data storage system 202 in FIG. 1B includes three controllers 204-206 and three data storage media 104-106. Controllers 204-206 communicate with host system 101 through one or more communications channels. A separate controller controls each data storage medium in system 202. Controller 204 controls read and write accesses from host 101 to data storage medium 104. Controller 205 controls read and write accesses from host 101 to data storage medium 105. Controller 206 controls read and write accesses from host 101 to data storage medium 106. For example, data storage medium 104 can be a magnetic disk, and magnetic disk 104 and controller 204 can be part of a hard disk drive. As another example, data storage medium 105 can be an optical disk, and optical disk 105 and controller 205 can be part of an optical disk drive.

Data storage systems 102 and 202 are configured to map logical block addresses (LBAs) to physical addresses in different types of non-volatile data storage media 104-106. The physical addresses typically have different numerical values than the LBAs, but the physical addresses and the LBAs can have the same numerical values. In a hard disk drive, the physical addresses can be cylinder head sector numbers.

Data storage media 104-106 in FIGS. 1A and 1B can be 3 different types of data storage media. The different types of data storage media 104-106 can, for example, use different techniques for storing data. For example, data storage media 104-106 can include a magnetic hard disk that stores data as magnetic patterns. As another example, data storage media 104-106 can include an optical disk such as a compact disc (CD) or digital video disc (DVD) that stores data as a set of optical images. As yet another example, data storage media 104-106 can include non-volatile semiconductor memory such as NAND Flash memory or another type of Flash memory that stores data as charge in circuits. As yet another example, data storage media 104-106 can include a magnetic tape that stores data as magnetic patterns. As yet another example, data storage media 104-106 can include a magnetic floppy disk. The data storage system 102 or 202 can also include data storage media of the same type, e.g., multiple hard disk platters, multiple optical disks, multiple Flash memory circuits, etc.

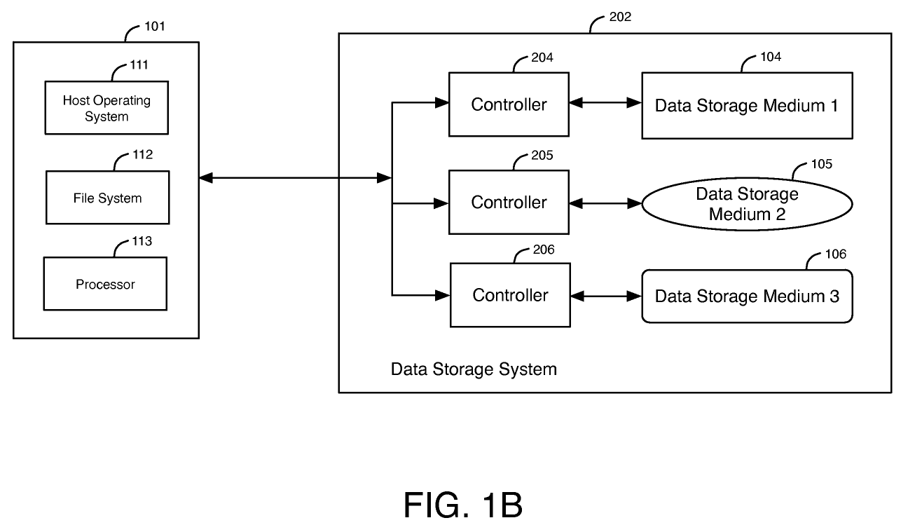

FIG. 2 illustrates an example of how a file system stores different parts of a file in different types of data storage media, according to an embodiment of the present invention. The file can include, for example, data, software code, or a combination thereof. In the example of FIG. 2, file system 112 stores three different portions of file 201 in three different types of media. File 201 has three different portions 201A, 201B, and 201C. File system 112 stores file portion 201A in data storage medium 104. File system 112 stores file portion 201B in data storage medium 105. File system 112 stores file portion 201C in data storage medium 106.

According to an embodiment, a file system automatically determines which data storage medium to use for storing each portion of a file based on the intrinsic value of the file or based on the intrinsic value of one or more portions of the file. A file system can, for example, select data storage media for storing portions of a file based on intrinsic values of a file such as an expected access time for portions of the file, an expected access rate for portions of the file, an expected sequential access time or rate for portions of the file, the value of the data or code in a portion of the file, the metadata sectors of the file, or a desired reliability of a portion of a file.

As a specific example, a file system and/or software application (e.g., a database application) may require a fast random access time and/or a fast random access rate to the data or code stored in a portion of a file. In this example, the file system stores the data or code in that portion of the file in Flash memory to provide a fast random access time and a fast random access rate to that data or code. One or more other portions of the file that do not require fast random access can be stored, for example, in a hard disk, in an optical disk, or in magnetic tape.

As another specific example, a file system or software application may require a fast sequential access time to the data or code in a portion of a file. Sequential access refers to reading or writing sectors in sequential order, i.e., a set of sectors that are adjacent to each other as written on the data storage medium. In this example, the file system stores the data or code in the portion of the file requiring fast sequential access in a hard disk or in an optical disk. One or more other portions of the file that do not require fast sequential access can be stored, for example, in Flash memory, or in magnetic tape.

As yet another specific example, a file system or software application may require a high degree of reliability for valuable data or code in one or more portions of a file. In this example, the file system stores the most valuable portions of the file in a highly reliable data storage medium. One or more other portions of the file can be stored in a less reliable storage medium.

As yet another specific example, the metadata portion of a file may have a different intrinsic value than the data portion of a file. The metadata portion of a file may be used for limited purposes, for example, to store the file's last access time. In this example, the file system stores the metadata portion 201A of the file 201 in a first data storage medium 104 and the data portions 201B and 201C of the file 201 in different data storage media. The file system stores the second portion 201B and the third portion 201C of the file in data storage media 105 and 106, respectively. The first data storage medium 104 can be a slower, less expensive medium, because the metadata portion 201A of the file is not accessed as often as the data portions 201B and 201C of the file.

According to another embodiment, a file system stores highly accessed parts of a file (e.g., the code portion of a Windows DLL executable file) in a faster, more expensive data storage medium. DLL stands for dynamic-link library. The file system stores the other parts of the file that are rarely accesses (e.g., the symbols in a Windows DLL executable file) in cheaper and slower media. These examples are provided for the purpose of illustration and are not intended to limit the scope of the present invention.

In some embodiments, the file system assigns different portions of a file to ranges of logical block addresses (LBAs) that map to different types of data storage media. The LBAs map to physical addresses in each of the data storage media. The physical addresses correspond to units of storage space in a particular data storage medium. Each data storage medium 104-106 has a physical address assigned to each of unit of storage space. Each physical address assigned to a unit of storage space in a data storage medium is unique with respect to the other physical addresses assigned to other units of storage space in that data storage medium.

Host 101 sends a range of LBAs to the data storage system with each read command and each write command to access data from data storage media 104, 105, and 106. After the data storage system receives a command and LBAs from host 101, a controller accesses the physical addresses in one or more of the data storage media 104-106 corresponding to the LBAs received from the host 101. The controller then reads data from or writes data to the one or more mapped data storage media 104-106. Further details of a data storage system that stores data in multiple different types of data storage media is described in commonly owned, U.S. Patent Application ______, (Attorney Docket number HSJ9-2007-0208-US1) filed concurrently herewith, which is incorporated by reference herein.

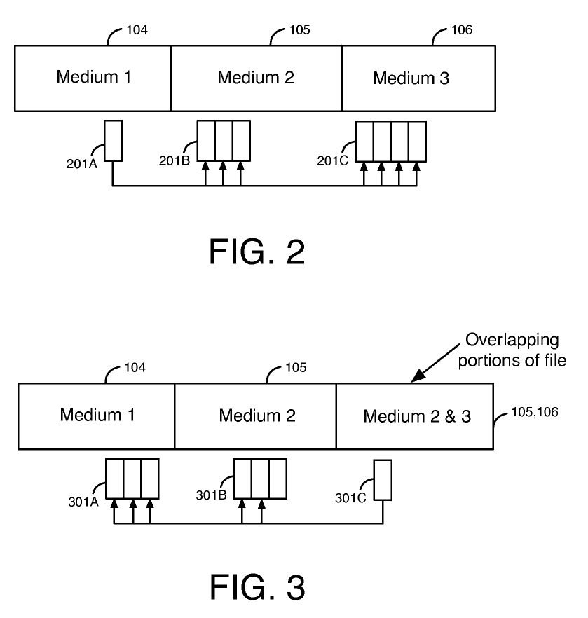

FIG. 3 illustrates an example of how a file system stores a portion of a file in two different types of data storage media, according to an embodiment of the present invention. A file system can selectively store one or more portions of a file in two or more different types of data storage media. As a result, the one or more portions of the file overlap (i.e., are mirrored to) at least two different types of data storage media.

In the embodiment of FIG. 3, a file system stores portion 301A of file 301 in data storage medium 104 and portion 301B of file 301 in data storage medium 105. The file system stores portion 301C of file 301 in data storage medium 105 and in data storage medium 106. Portion 301C can be, for example, the metadata portion of the file.

By storing a portion of a file in two or more different types of data storage media, file system 112 significantly increases the reliability of the data associated with that portion of the file, without having to store the entire file on two different data storage media.

In addition, storing a portion of a file in two different types of data storage media can also significantly decrease the read access time for that portion of the file. For example, Flash memory devices typically have fast random access times and slower sequential data transfer times. Hard disk drives typically have fast sequential data transfer times for accessing a sequential range of physical addresses and slower random access times. Thus, file system 112 can significantly decrease the read access time of data that is stored on both Flash memory and on a magnetic hard disk. Each time that host 101 requests data, the data are accessed from both the Flash memory and the hard disk. Whichever data storage medium is faster at accessing that data returns the data to the controller first. Then, the data received at the controller first are transferred to host 101.

Storing a portion of a file in two different types of data storage media can also significantly decrease the write time. For example, file system 112 can immediately write data associated with a portion of a file to the data storage medium that performs faster write operations. Then, file system 112 can copy the data associated with that portion of the file from the faster data storage medium to the other, slower data storage medium in the background, after the data has been written to the faster data storage medium. This technique ensures that the data is written onto at least one data storage medium soon after the write command is issued, while the data is copied to a second data storage medium later when host 101 is less busy.

According to yet another embodiment, data storage system 102 or 202 can store a portion of a file in three (or more) different types of data storage media.

According to some embodiments, a file system dynamically moves one or more portions of a file from one type of data storage medium to a different type of data storage medium if the intrinsic value of one or more portions of the file changes. For example, a file system can dynamically move a portion of a file from Flash memory to an optical disk or to a magnetic hard disk to increase the reliability of that portion of the file or to increase the sequential access time. As another example, a file system can move a portion of a file to a different type of data storage medium if the original data storage medium allocated to that portion of the file crashes or no longer provides a fast data access time for a particular application.

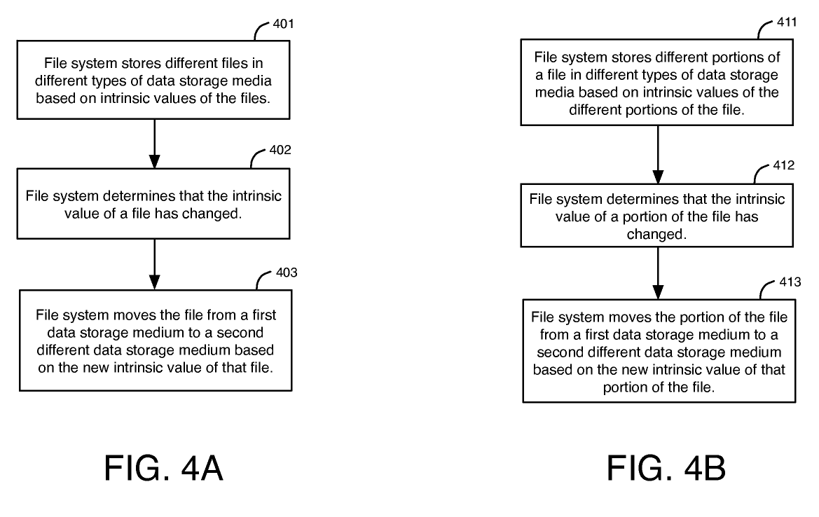

FIG. 4A is a flow chart that illustrates a process for a file system to dynamically move a file from one type of data storage medium to another type of data storage medium, according to an embodiment of the present invention. In step 401, file system 112 stores different files in different types of data storage media based on intrinsic values of the files.

At step 402, file system 112 determines that the intrinsic value of one of the files has changed. Alternatively, file system 112 can change the intrinsic value of one of the files at step 402. At step 403, file system 112 moves the file from a first data storage medium to a second different data storage medium based on the new intrinsic value of that file. The first and the second data storage media are different types of data storage media.

FIG. 4B is a flow chart that illustrates a process for a file system to dynamically move a portion of a file from one type of data storage medium to another type of data storage medium, according to an embodiment of the present invention. At step 411, file system 112 stores different portions of a file in different types of data storage media based on intrinsic values of the different portions of the file. At step 412, file system 112 determines that the intrinsic value of one portion of the file has changed. Alternatively, file system 112 changes the intrinsic value of one portion of the file at step 412. At step 413, file system 112 moves that portion of the file from a first data storage medium to a second different data storage medium based on the new intrinsic value of that portion of the file. The first and the second data storage media can be different types of data storage media.

According to another embodiment, file system 112 dynamically moves a portion of a file from one overlapping data storage medium to another. For example, file system 112 can move portion 301C of file 301 from data storage medium 105 to data storage medium 104. Portion 301C of file 301 then overlaps media 104 and 106.

The foregoing description of the exemplary embodiments of the present invention has been presented for the purposes of illustration and description. It is not intended to be exhaustive or to limit the present invention to the examples disclosed herein. A latitude of modification, various changes, and substitutions are intended in the present invention. In some instances, features of the present invention can be employed without a corresponding use of other features as set forth. Many modifications and variations are possible in light of the above teachings, without departing from the scope of the present invention.

For example, embodiments of the present invention may be implemented using one or a combination of hardware, software, and a computer-readable medium containing program instructions. Software implemented by embodiments of the present invention and results of the present invention may be stored on a computer-readable medium such as memory, hard disk drive, CD, DVD, or other media. Results of the present invention may be used for various purposes such as being executed or processed by a processor, being displayed to a user, transmitted in a signal over a network, etc.

What is claimed is:

1. A host system comprising:
a file system; and
a processor for executing the file system, wherein the file system stores a first portion of a first file in a first data storage medium and a second portion of the first file in a second data storage medium based on an intrinsic value of at least a part of the first file, and the first and the second data storage media are different types of data storage media.

2. The host system defined in claim 1 wherein the file system dynamically moves the second portion of the first file from the second data storage medium to a third data storage medium in response to a change in an intrinsic value of the second portion of the first file, wherein the first, the second, and the third data storage media are three different types of data storage media.

3. The host defined in claim 1 wherein the file system stores a second file on the first data storage medium, and the file system dynamically moves the second file to the second data storage medium.

4. The host system defined in claim 1 wherein the file system stores a third portion of the first file in a third data storage medium based on an intrinsic value of the third portion of the first file, wherein the first, the second, and the third data storage media are three different types of data storage media.

5. The host system defined in claim 1 wherein the first portion of the first file is a metadata portion of the first file.

6. The host system defined in claim 1 wherein the intrinsic value of the first file is at least one of an access time, an access rate, metadata, and a reliability parameter.

7. The host system defined in claim 1 wherein the file system stores the first portion of the first file in the first data storage medium based on the intrinsic value of the first portion of the first file, and the file system stores the second portion of the first file in the second data storage medium based on an intrinsic value of the second portion of the first file.

8. The host system defined in claim 7 wherein the file system dynamically moves the first portion of the first file from the first data storage medium to the second data storage medium in response to a change in the intrinsic value of the first portion of the first file.

9. The host system defined in claim 1 wherein the file system stores the second portion of the first file in the second data storage medium and in a third data storage medium, wherein the second and the third data storage media are different types of data storage media.

10. The host system defined in claim 9 wherein the file system dynamically moves the second portion of the first file from the second data storage medium to the first data storage medium.

11. The host system defined in claim 1 wherein the first and the second data storage media are selected from the group consisting of magnetic hard disk, magnetic tape, optical disk, and Flash semiconductor memory.

12. A host system comprising:
a file system; and
a processor for executing the file system, wherein the file system stores a first file in a first data storage medium based on an intrinsic value of the first file, the file system stores a second file in a second data storage medium based on an intrinsic value of the second file, and the file system dynamically moves the second file from the second data storage medium to the first data storage medium in response to a change in the intrinsic value of the second file, wherein the first and the second data storage media are different types of data storage media.

13. The host system defined in claim 12 wherein the file system stores a first portion of a third file in the first data storage medium and a second portion of the third file in the second data storage medium based on intrinsic values of the first and the second portions of the third file.

14. The host system defined in claim 13 wherein the file system dynamically moves the first portion of the third file from the first data storage medium to the second data storage medium in response to a change in the intrinsic value of the first portion of the third file.

15. The host system defined in claim 13 wherein the file system stores the second portion of the third file in the second data storage medium and in a third data storage medium, wherein the second and the third data storage media are different types of data storage media.

16. The host system defined in claim 12 wherein the file system stores a third file in a third data storage medium based on an intrinsic value of the third file, wherein the first, the second, and the third data storage media are three different types of data storage media.

17. The host system defined in claim 12 wherein the first and the second data storage media are selected from the group consisting of magnetic hard disk, magnetic tape, optical disk, and Flash semiconductor memory.

18. The host system defined in claim 12 wherein the intrinsic values of the first and the second files are each selected from the group consisting of an access time, an access rate, metadata, and a reliability parameter.

19. A host system that comprises code for storing portions of a file on multiple different types of data storage media, wherein the code is stored in a computer readable medium in the host system, the host system comprising:
code for allocating a first portion of a file for storage in a first data storage medium and a second portion of the file for storage in a second data storage medium using a file system based on intrinsic values of the first and the second portions of the file, wherein the first and the second data storage media are different types of data storage media; and
code for dynamically moving the first portion of the file from the first data storage medium to the second data storage medium using the file system in response to a change in the intrinsic value of the first portion of the file.

20. The host system defined in claim 19 wherein the first portion of the file is a metadata portion of the file, and the second portion of the file is a data portion of the file.
